(19) United States
(12) Patent Application Publication
(10) Pub. No.: US 2025/0039970 A1
(43) Pub. Date: Jan. 30, 2025

(54) METHOD AND APPARATUS FOR TRANSMITTING AND RECEIVING FAILURE INFORMATION AND SYSTEM

(71) Applicant: FUJITSU LIMITED, Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: FUJITSU LIMITED, Kawasaki-shi (JP)

(21) Appl. No.: 18/916,829

(22) Filed: Oct. 16, 2024

Related U.S. Application Data
(63) Continuation of application No. PCT/CN2022/087660, filed on Apr. 19, 2022.

(51) Int. Cl. H04W 76/19; H04W 24/10; H04W 76/20; H04W 92/18

(52) U.S. Cl. CPC H04W 76/19; H04W 24/10; H04W 76/20; H04W 92/18

(57) ABSTRACT

Embodiments of this disclosure provide a method and apparatus for transmitting failure information and a system. The method for transmitting failure information includes: transmitting configuration information to a remote user equipment, the configuration information including information for adding and/or modifying and/or deleting a path, the path being a direct path and/or an indirect path between the remote user equipment and a network device.

### CROSS-REFERENCE TO RELATED APPLICATION

This application is a continuation application of International Application No. PCT/CN2022/087660 filed on Apr. 19, 2022, and designated the U.S., the entire contents of which are incorporated herein by reference.

### FIELD

This disclosure relates to the field of communication.

### BACKGROUND

In Release 17, sidelink relay (SL relay) was studied, which includes a scenario of UE-to-Network relay. In this scenario, a remote UE communicates with a network device via a relay UE, wherein NR Uu is used on a Uu link of the relay user equipment, and an NR sidelink is used on a PC5 interface between the remote UE and the relay UE. In the scenario of UE-to-Network relay, the relay UE is also referred to as a UE-to-Network relay UE.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in UE-to-Network relay in Release 17, a single path is only supported, that is, the remote UE communicates with the network device (such as a gNB) via the relay UE. The remote UE in an RRC_Connected state suspends radio link monitoring (RLM) of the Uu interface.

The relay UE performs radio link monitoring on its own Uu interface. If a Uu RLF is detected, the relay UE transmits a message to the remote UE to notify the remote UE of occurrence of a Uu RLF. This message triggers an RRC connection reestablishment procedure of the remote UE.

In addition, the remote UE performs radio link quality monitoring of the PC5 interface, such as detecting whether a PC5 RLF occurs based on sidelink HARQ feedback of the PC5 interface. If the remote UE detects a PC5 RLF, the remote UE in the RRC_Connected state may also trigger RRC connection reestablishment.

As the remote UE in Release 17 does not support communication with the network by using more than one paths, if RRC connection reestablishment is triggered when the remote UE detects an RLF of the PC5 interface or receives a PC5-RRC message transmitted by the relay UE notifying the relay UE of the Uu RLF, or if RRC connection reestablishment is triggered when the remote UE detects an RLF in the Uu interface, an interruption time of services of the remote UE is relatively long, which may increase transmission latency, and lower user experiences.

In Release 18, solutions that support multi-path or multiple paths will be studied. A multi-path scenario may be that a remote UE is connected to the same network device (e.g. a gNB) by using a direct path and an indirect path. For example, the direct path may be that the remote UE is connected directly to the network device via a Uu interface, and the indirect path may be that the remote UE is connected to the network device via a layer-2 (L2) UE-to-Network relay.

At present, in the multi-path solution, there is no solution for how to reduce interruption times of services of user equipments when a path fails.

In order to solve at least one of the above problems, embodiments of this disclosure provide a method and apparatus for transmitting and receiving failure information and a system.

According to an aspect of the embodiments of this disclosure, there is provided an apparatus for transmitting failure information of a remote user equipment, the remote user equipment being configured or activated with a first path and a second path, the apparatus including: a transmitting unit configured to transmit failure information to a network device via the second path in a case where the first path fails.

According to another aspect of the embodiments of this disclosure, there is provided a method for transmitting failure information of a remote user equipment, the remote user equipment being configured or activated with a first path and a second path, the method including: transmitting failure information to a network device via the second path in a case where the first path fails.

According to a further aspect of the embodiments of this disclosure, there is provided a remote user equipment, including a memory and a processor, the memory storing a computer program, and the processor being configured to execute the computer program to carry out the method for transmitting failure information as described in the other aspect of the embodiments of this disclosure.

According to still another aspect of the embodiments of this disclosure, there is provided an apparatus for receiving failure information, including: a receiving unit configured to, in a case where a first path fails, receive via a second path, failure information transmitted by a remote user equipment, wherein the remote user equipment is configured or activated with the first path and the second path.

According to yet another aspect of the embodiments of this disclosure, there is provided a method for receiving failure information, including: in a case where a first path fails, receiving via a second path, failure information transmitted by a remote user equipment, wherein the remote user equipment is configured or activated with the first path and the second path.

According to yet still another aspect of the embodiments of this disclosure, there is provided a network device, including a memory and a processor, the memory storing a computer program, and the processor being configured to execute the computer program to carry out the method for receiving failure information as described in the yet another aspect of the embodiments of this disclosure.

According to yet further another aspect of the embodiments of this disclosure, there is provided a communication system, including the network device as described in the yet still another aspect of the embodiments of this disclosure and/or the remote user equipment as described in the further aspect of the embodiments of this disclosure.

One of the advantages of the embodiments of this disclosure exists in that the remote UE is configured or activated with more than one paths (a first path and a second path), and in a case where the first path fails, the remote UE transmits failure information to a network device via the second path. Hence, interruption times of services of the user equipment may be reduced, transmission latency of the services may be ensured, and user experiences may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of a scenario 1 of remote UE-to-Network relay;

FIG. 2 is a schematic diagram of a scenario 2 of remote UE-to-Network relay;

FIG. 3 is a schematic diagram of a scenario 3 of remote UE-to-Network relay;

FIG. 4 is a schematic diagram of a communication system of embodiments of this disclosure;

FIG. 5 is a schematic diagram of a multi-path scenario of embodiments of this disclosure;

FIG. 6 is a schematic diagram of a multi-path protocol stack structure of embodiments of this disclosure;

FIG. 7 is a schematic diagram of the method for transmitting failure information of a first aspect of the embodiments of this disclosure;

FIG. 8 is a schematic diagram of a scenario of a path failure of the first aspect of the embodiments of this disclosure;

FIG. 9 is another schematic diagram of the scenario of the path failure of the first aspect of the embodiments of this disclosure;

FIG. 10 is a further schematic diagram of the scenario of the path failure of the first aspect of the embodiments of this disclosure;

FIG. 11 is still another schematic diagram of the scenario of the path failure of the first aspect of the embodiments of this disclosure;

FIG. 12 is a schematic diagram of the apparatus for transmitting failure information of a second aspect of the embodiments of this disclosure;

FIG. 13 is a schematic diagram of the method for receiving failure information of a third aspect of the embodiments of this disclosure;

FIG. 14 is a schematic diagram of the apparatus for receiving failure information of a fourth aspect of the embodiments of this disclosure;

FIG. 15 is a schematic diagram of a structure of the terminal equipment of a fifth aspect of the embodiments of this disclosure; and

FIG. 16 is a schematic diagram of a structure of the network device of the fifth aspect of the embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment, except otherwise specified.

Scenarios of UE-to-Network relay shall be described below by way of examples; however, this disclosure is not limited thereto.

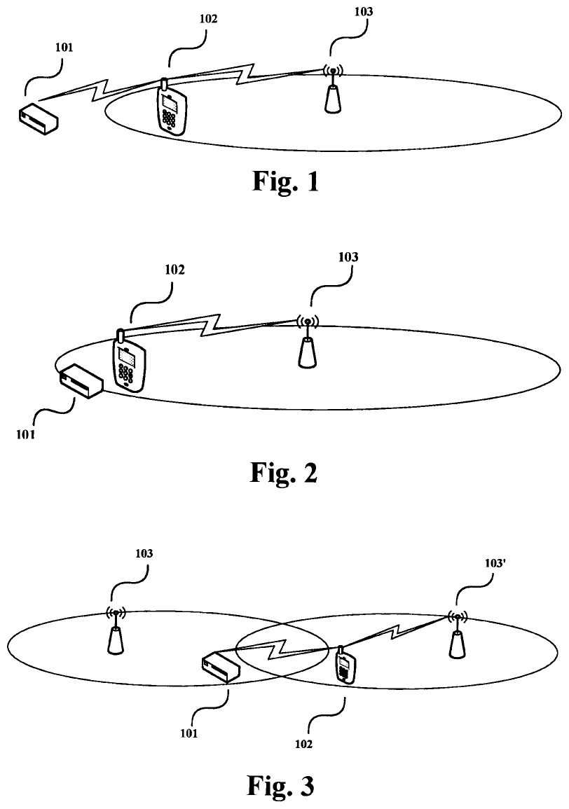

FIG. 1 is a schematic diagram of a scenario 1 of remote UE-to-Network relay, FIG. 2 is a schematic diagram of a scenario 2 of remote UE-to-Network relay, and FIG. 3 is a schematic diagram of a scenario 3 of remote UE-to-Network relay.

As shown in FIG. 1, in scenario 1, a first terminal equipment 101 (remote UE) is out of coverage (OOC) of a network device 103, and a second terminal equipment 102 (relay UE) is in coverage (IC) of the network device 103.

As shown in FIG. 2, in scenario 2, the first terminal equipment 101 (remote user equipment) is in coverage (IC) of the network device 103, and the second terminal equipment 102 (relay user equipment) is in coverage (IC) of the network device 103.

As shown in FIG. 3, in scenario 3, the first terminal equipment 101 (remote user equipment) is in coverage of the network device 103, and the second terminal equipment 102 (relay user equipment) is in coverage of another network device 103′.

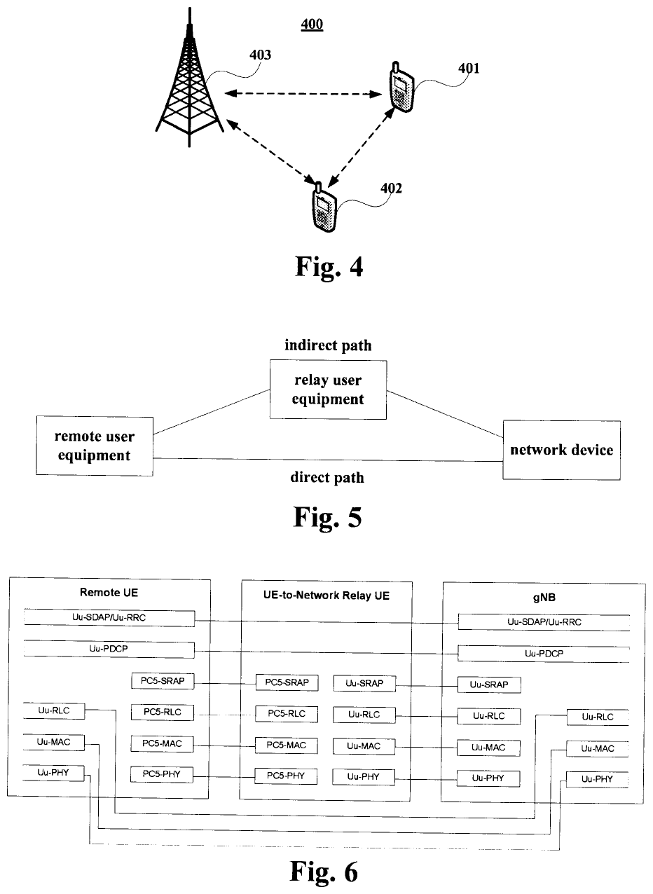

FIG. 4 is a schematic diagram of a communication system of embodiments of this disclosure, illustrating a case taking a remote user equipment, a relay user equipment and a network device as an example. As shown in FIG. 4, the communication system 400 may include a remote user equipment 401, a relay user equipment 402 and a network device 403. The remote user equipment 401 is connected to the network device 403 via a direct path and an indirect path. For the sake of simplicity, description is given in FIG. 4 by taking two terminal equipments (one remote user equipment and one relay user equipment) and one network device as an example; however, the embodiments of this disclosure are not limited thereto.

In the embodiments of this disclosure, existing services or services that may be implemented in the future may be performed between the network device 403 and the remote user equipment 401 and the relay user equipment 402. For example, such services may include but not limited to an enhanced mobile broadband (eMBB), massive machine type communication (MTC), ultra-reliable and low-latency communication (URLLC), etc.

FIG. 5 is a schematic diagram of a multi-path scenario of embodiments of this disclosure. As shown in FIG. 5, in the embodiments of this disclosure, the remote user equipment may communicate with the network device via a direct path and an indirect path simultaneously. For example, the remote user equipment may communicate with the network device via a Uu interface (direct path), and communicate with the same network device via the relay user equipment (indirect path).

FIG. 6 is a schematic diagram of a multi-path protocol stack structure of embodiments of this disclosure. As shown in FIG. 6, the direct path between the remote user equipment and the network device uses a Uu interface protocol stack, and the indirect path between the remote user equipment and the network device is transmitted via L2 UE-to-Network relay, using the PC5 interface and a Uu interface protocol stack.

In some embodiments, as shown in FIG. 6, an RRC layer, an SDAP layer and a PDCP layer in the remote user equipment are equivalent to an RRC layer, an SDAP layer and a PDCP layer in the network device, and data of the PDCP layer of remote user equipment may be transmitted to the network device via the indirect path passing the relay user equipment. For example, a PDCP PDU of the remote user equipment may be transmitted to the relay UE via a PC5-SRAP, a PC5-RLC, a PC5-MAC and a PC5-PHY, and then the relay UE transmits the data to a gNB via its own Uu interface protocol stack (a Uu SRAP, a Uu RLC, a Uu MAC, and a Uu PHY). The gNB side receives the data from a Uu interface protocol stack peer to the relay UE, and transmits the data to the Uu-PDCP of the gNB for processing. Or, data of the PDCP layer of the remote user equipments may be transmitted to the network device via a direct path. For example, the PDCP PDU of the remote user equipment may be transmitted to the gNB via a Uu RLC, a Uu MAC, and a Uu PHY. The gNB side receives the data from a Uu interface protocol stack peer to the remote UE, and transmits the data to the Uu-PDCP of the gNB for processing. In addition, in the direct path and/or the indirect path, there may be one or more RLC entities (Uu RLC entities or PC5 RLC entities) associated with a PDCP entity of a radio bearer.

In some embodiments, in the protocol stack of the gNB side, one Uu MAC entity may also be used to process data of the remote user equipment and the relay user equipment.

In some embodiments, in the remote user equipment, one MAC entity may also be used to perform PC5-MAC and Uu MAC operations.

Various implementations of the embodiments of this disclosure shall be described below with reference to the accompanying drawings. These implementations are illustrative only, and are not intended to limit this disclosure.

### Embodiments of a First Aspect

The embodiments of this disclosure provide a method for transmitting failure information. The method is applicable to a remote UE, such as the remote UE 401 in FIG. 4.

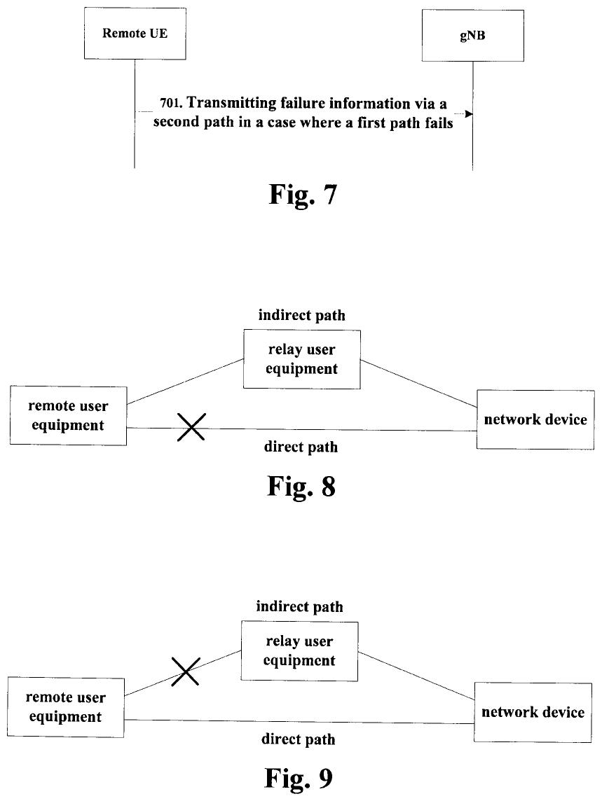

FIG. 7 is a schematic diagram of the method for transmitting failure information of a first aspect of the embodiments of this disclosure. As shown in FIG. 7, the method includes:
701: transmitting failure information to a network device via a second path in a case where a first path fails.

It should be noted that FIG. 7 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

According to the above embodiment, the remote UE is configured or activated with more than one paths (a first path and a second path), and in a case where the first path fails, the remote UE transmits failure information to a network device via the second path. Hence, interruption times of services of the user equipment may be reduced, transmission latency of the services may be ensured, and user experiences may be improved.

In some embodiments, the remote UE is configured or activated with at least 2 paths (a first path and a second path), and the remote UE may communicate with the network device via at least one path. In a case where the first path in the at least 2 paths fails, the remote UE transmits the failure information to the network device via the available second path in the at least 2 paths.

In some embodiments, the remote UE is configured with at least 2 paths (a first path and a second path). For a signaling radio bearer, at least one of the at least two paths is activated or may be used. And for a data radio bearer, the at least two paths may be activated, or one of them is activated while the other one is not activated, or neither of them is activated.

In some embodiments, the remote UE is activated with at least 2 paths (a first path and a second path). For at least one data radio bearer, the remote UE may communicate with the network device via the at least two paths, such as communicating with the network device via the first path and the second path.

In some embodiments, the first path may be a direct path or an indirect path, and the second path may be a direct path or an indirect path. For example, the first path is a direct path, and the second path is an indirect path. For another example, the first path is an indirect path, and the second path is a direct path.

In some embodiments, the path failure may include at least one of the following cases where: the remote user equipment detects a radio link failure (RLF) of a PC5 interface of the remote user equipment; the remote user equipment receives a notification of an RLF of a Uu interface of a relay user equipment or a failure of radio resource control (RRC) connection of the relay user equipment or handover of the relay user equipment or a failure of beam failure recovery of the relay user equipment transmitted by the relay user equipment; the remote user equipment detects a beam failure of a PC5 interface or a failure of performing beam failure recovery (for example, the remote user equipment makes an attempt to perform beam failure recovery after detecting the beam failure of the PC5 interface, but the recovery fails); establishment of PC5 connection between the remote user equipment and the relay user equipment fails, for example, the remote user equipment does not discover or select or reselect the relay user equipment, or does not receive a direct communication accept message of the relay user equipment, or receives a direct communication reject message of the relay user equipment, or is unable to comply with configuration therein after receiving an RRC reconfiguration sidelink of the relay user equipment, or receives an RRC reconfiguration sidelink failure information of the relay user equipment, etc.; the remote user equipment detects an RLF of a Uu interface of the relay user equipment, for example, the remote user equipment performs radio link monitoring (RLM) on the Uu interface, and deems that an RLF is detected when T310 timer expires; the remote user equipment detects a beam failure of the Uu interface or fails in performing BFR; synchronous reconfiguration of the PC5 interface and/or Uu interface of the remote user equipment fail(s), for example, the remote user equipment receives an RRC reconfiguration message containing a reconfiguration with sync IE, and performs a path switch procedure at the PC5 interface or performs a random access procedure at the Uu interface, but the procedure is unsuccessful (for example, a path switch timer or T304 timer expires, etc.); or the PC5 interface and/or Uu interface configuration of the remote user equipment fail(s), for example, the remote user equipment is unable to comply with configuration of the network device for the PC5 interface and/or Uu interface, etc. That is, the path failure may include any one of the above cases or a combination thereof.

For example, in the case where the first path is a direct path, the first path failure may include at least one of the following cases where: the remote UE detects an RLF of the Uu interface; the remote UE detects a beam failure or BFR of the Uu interface; synchronization reconfiguration of the Uu interface of the remote UE fails; or, configuration of the Uu interface of the remote UE fails. That is, the path failure of the direct path may include any one of the above cases or a combination thereof.

FIG. 8 is a schematic diagram of a scenario of the path failure in the first aspect of the embodiments of this disclosure, showing a scenario of a failure of the direct path. As shown in FIG. 8, the failure of the direct path may be a failure of the Uu interface between the remote UE and the network device. In this case, the remote UE may transmit the failure information to the network device via an available indirect path.

For another example, in the case where the first path is an indirect path, the failure of the first path may include at least one of the following cases where: the remote UE detects an RLF of the PC5 interface; the remote UE detects a beam failure or BFR of the PC5 interface; the remote UE receives a notification of an RLF of the Uu interface of the relay user equipment or an RRC connection failure of the relay user equipment or the handover of the relay user equipment or a BFR failure of the relay user equipment transmitted by the relay user equipment; establishment of PC5 connection between the remote UE and relay user equipment fails; PC5 interface synchronization reconfiguration of the remote user equipment fails; or, PC5 interface configuration of the remote UE fails. That is, the path failure of the indirect path may include any one of the above cases or a combination thereof.

FIG. 9 is another schematic diagram of the scenario of the path failure of the first aspect of the embodiments of this disclosure, showing a scenario of a failure of the indirect path. As shown in FIG. 9, the failure of the indirect path may be a failure of a PC5 interface between the remote UE and the relay user equipment.

For example, in a case where the remote UE detects the RLF of the PC5 interface, or detects the beam failure of the PC5 interface or fails in performing BFR, or establishment of PC5 connection between the remote UE and the relay user equipment fails, or synchronization reconfiguration of the PC5 interface of the remote UE fails, or configuration of the PC5 interface of the remote UE fails, it is determined that the PC5 interface between the remote UE and the relay user equipment fails.

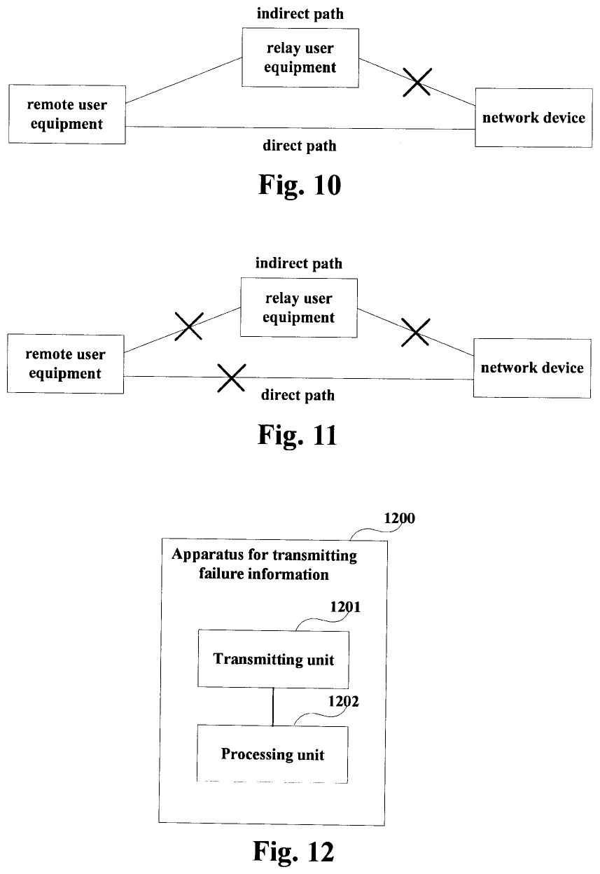

FIG. 10 is a further schematic diagram of the scenario of the path failure of the first aspect of the embodiments of this disclosure, showing a scenario of a failure of the indirect path. As shown in FIG. 10, the failure of the indirect path may be a radio link failure of a Uu interface between the relay user equipment and the network device.

For example, according to the notification of the RLF of the Uu interface of the relay user equipment or the failure of the RRC connection of the relay user equipment or the handover of the relay user equipment or the failure of BFR of the relay user equipment transmitted by the relay user equipment, the remote UE may determine that the Uu interface between relay user equipments and network device fails.

In some embodiments, the notification of the RLF of the Uu interface of the relay user equipment or the failure of the RRC connection of the relay user equipment or the handover of the relay user equipment or the failure of BFR of the relay user equipment may be transmitted via a PC5-RRC messages; however, this disclosure is not limited thereto, and the above information may also be transmitted in other manners.

FIGS. 9 and 10 respectively show the PC5 interface failure and the Uu interface failure in the indirect path. However, this disclosure is not limited thereto, and the indirect path failure may also be both the PC5 interface failure and the Uu interface failure.

In some embodiments, in the case of the indirect path failure, the remote UE may transmit the failure information to the network device via an available direct path.

In some embodiments, in the case of the indirect path failure, the remote UE may trigger a relay reselection procedure with no need of waiting for configuration information of the network device. In this procedure, the remote UE may still be kept in the RRC_Connected state; however, this disclosure is not limited thereto. In the case of the indirect path failure, the remote UE may perform a relay reselection procedure after receiving the configuration information transmitted by the network device. Or, in a case where the indirect path fails and the direct path is available, the remote UE may not trigger a relay reselection procedure. For example, in case where there exists no available path between the remote UE and the network device, such as when both the direct path and the indirect path fail, the remote UE triggers a relay reselection procedure.

In some embodiments, the second path used for transmitting the failure information is an available path, the available path satisfying at least one of the following conditions that:
channel quality of the available path is higher than a first threshold;
channel quality of the available path satisfies criteria for cell selection and/or cell reselection;
channel quality of the available path satisfies criteria for relay selection and/or relay reselection;
the available path is an indirect path and no radio link failure or beam failure or beam failure recovery failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and synchronization reconfiguration failure of the PC5 interface of the remote user equipment does not occur on the indirect path;
the available path is an indirect path and configuration failure of the PC5 interface of the remote user equipment does not occur on the indirect path;
the available path is an indirect path and a failure of establishment of PC5 connection with the relay user equipment does not occur on the indirect path;
the available path is a direct path and a radio link failure or a beam failure or a failure of beam failure recovery of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or
the available path is not deactivated or de-configured.

That is, the available path may satisfy any one of the above conditions or a combination thereof.

For example, when the available path is a direct path, the available path satisfies at least one of the following conditions that:
channel quality of the available path is higher than a first threshold;
channel quality of the available path satisfies criteria for cell selection and/or cell reselection;
the available path is a direct path and an RLF or a beam failure or a BFR failure of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or the available path is not deactivated or de-configured.

For example, when the available path is an indirect path, the available path satisfies at least one of the following conditions that:
channel quality of the available path is higher than a first threshold;
channel quality of the available path satisfies criteria for cell selection and/or cell reselection;
the available path is an indirect path and no RLF or beam failure or BFR failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and a failure of establishment of PC5 connection with the relay user equipment does not occur on the indirect path;
the available path is a direct path and no synchronization reconfiguration failure of the Uu interface of the remote user equipment occurs on the direct path;
the available path is a direct path and no Uu interface configuration failure of the remote user equipment occurs on the direct path; or the available path is not deactivated or de-configured.

In some embodiments, the channel quality of the path is a result of measuring the path by the remote user equipment, the result of measuring including, for example, Uu reference signal receiving power (RSRP) or sidelink reference signal receiving power (SL-RSRP) or sidelink discovery reference signal receiving power (SD-RSRP). However, this disclosure is not limited thereto, and the result of measuring may also include other information, and the channel quality of the path may also be a result of measuring the path transmitted by the relay user equipment, etc.

In some embodiments, the first threshold may be predefined or may be configurable.

In some embodiments, the failure information transmitted by the remote user equipment to the network device may include at least one of the following:
failure indication information, failure type information, a measurement result of a serving cell, measurement results of other cells and/or frequencies, a measurement result of a connected relay user equipment, or measurement results of other relay user equipments. That is, the failure information may include any piece of the above information or a combination thereof.

For example, when the failed first path is a direct path, the failure information may include at least one of the following: failure indication information, failure type information, a measurement result of a serving cell, measurement results of other cells and/or frequencies, etc.

For example, when the failed first path is an indirect path, the failure information may include at least one of the following: failure indication information, failure type information, a measurement result of a connected relay user equipment, or measurement results of other relay user equipments, etc.

In some embodiments, the failure indication information may be used to notify the network device of specific contents of the path failure. Thus, the network device may perform corresponding operations according to the specific contents, such as transmitting corresponding information to the remote UE and/or the relay user equipment. The failure indication information may include at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), relay UE HO (handover of the relay user equipment), a relay UE RRC failure (radio resource control connection failure of the relay user equipment), a Relay UE BFR failure (failure of beam failure recovery of the relay user equipment), a PC5 connection failure (failure of establishment of PC5 connection), a Uu reconfiguration with sync failure (failure of synchronous reconfiguration of a Uu interface, a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

In some embodiments, the failure type information may be used to notify the network device of a cause for the path failure. The failure type information may include at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

In some embodiments, the failure type transmitted by the relay user equipment may be transmitted via a PC5-RRC message; however, this disclosure is not limited thereto, and the relay user equipment may also transmit the failure type in other means.

In some embodiments, in a case where there exists no available second path, such as when both the first path and second path fail, the remote user equipment may trigger an RRC connection reestablishment procedure.

FIG. 11 is still another schematic diagram of the scenario of the path failure of the first aspect of the embodiments of this disclosure, showing a scenario where both the direct path and the indirect path fail. In this case, the remote UE triggers the RRC connection reestablishment procedure. In other words, in a case where both the direct path and the indirect path between the remote UE and the network device fail, the remote UE may trigger the RRC connection reestablishment procedure.

In some embodiments, split transmission and duplication transmission may be used for both the direct path and the indirect path. When the split transmission is used, the direct path and the indirect path may transmit different data, such as different PDCP PDUs. Hence, throughput may be increased. When the duplication transmission is used, both the direct path and the indirect path may transmit identical data, such as transmitting identical PDCP PDUs. Thus, reliability of data transmission of the remote UE may be ensured.

In some embodiments, in a case where there exist more than one paths between the remote UE and the network device, a primary path and secondary paths may be provided in the more than one paths. For example, one path in the more than one paths may be selected as a primary path, and the other paths therein may be taken as secondary paths.

In some embodiments, the primary path may be a main path responsible for split transmission. For example, the primary path may be a path used for transmission of PDCP control PDUs related to a radio bearer in a case where PDCP duplication is activated, or a path used for transmission of PDCP PDUs when an amount of PDCP data and/or an amount of RLC data waiting for initial transmission is/are less than a threshold in a case where PDCP duplication is deactivated, wherein an RLC entity to which the primary path corresponds may be referred to as a primary RLC entity, and the secondary paths may be paths responsible for split transmission or duplication transmission other than the primary path. For example, when the remote UE uses two paths, a path other than a primary path is a secondary path.

In some embodiments, in a case where the first path fails and the first path is a primary path, the remote user equipment may trigger the RRC connection reestablishment procedure.

In some embodiments, in a case where the first path fails, the first path is a secondary path, the second path is available and the second path is a primary path, the failure information is transmitted to the network device via the second path.

Therefore, when the secondary path fails and the primary path is available, the remote user equipment transmits the failure information to the network device without triggering an RRC reestablishment procedure; and when the primary path fails, the remote UE triggers the RRC connection reestablishment procedure. Hence, interruption times of services of the user equipment may be reduced.

In some embodiments, the primary path and/or the secondary paths may be configured by the network device or may be predefined; however, this disclosure is not limited thereto, and the primary path and/or the secondary paths may be selected by the remote UE.

In some embodiments, the primary path and secondary paths may be selected or set according to various rules. For example, the direct path is taken as a primary path, and the indirect path is taken as a secondary path. For another example, a path of good channel quality is taken as a primary path, and a path of poor channel quality is taken as a secondary path, and so on. In addition, a path containing a primary RLC entity (or a primary RLC channel or a primary logical channel, etc.) may be taken as a primary path, and/or a path containing a secondary RLC entity (or a secondary RLC channel or a secondary logical channel, etc.) or containing no primary RLC entity (or primary RLC channel or primary logical channel, etc.) may be taken as a secondary path, wherein the primary RLC entity (or primary RLC channel or primary logical channel, etc.) may be configured by the network device.

In some embodiments, the remote UE may transmit the failure information via an RRC message; however, this disclosure is not limited thereto, and the failure information may also be transmitted in other means.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiments that the remote UE is configured or activated with more than one paths (a first path and a second path), and in the case where the first path fails, the remote UE transmits the failure information to the network device via the second path. Hence, interruption times of services of the user equipment may be reduced, transmission latency of the services may be ensured, and user experiences may be improved.

### Embodiments of a Second Aspect

The embodiments of this disclosure provide an apparatus for transmitting failure information. The apparatus may be, for example, a remote user equipment (such as the remote user equipment 401 described above), or may be one or some components or assemblies configured in the remote user equipment, with contents identical to those in the embodiments of the first aspect being not going to be described herein any further.

FIG. 12 is a schematic diagram of the apparatus for transmitting failure information of the second aspect of the embodiments of this disclosure. As shown in FIG. 12, the apparatus 1200 for transmitting failure information includes:
a transmitting unit 1201 configured to transmit failure information to a network device via a second path in a case where a first path fails.

In some embodiments, the remote UE is configured or activated with at least two paths (the first path and the second path). The remote user equipment may communicate with the network device via at least one path. In a case where the first path in the at least two paths fails, the remote UE transmits the failure information to the network device via the available second path in the at least two paths.

In some embodiments, the first path may be a direct path or an indirect path, and the second path may be a direct path or an indirect path. For example, the first path is a direct path, and the second path is an indirect path. For another example, the first path is an indirect path, and the second path is a direct path.

In some embodiments, the path failure may include at least one of the following cases where:
a radio link failure of a PC5 interface of the remote user equipment or a beam failure or a failure of performing beam failure recovery is detected;
a notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
establishment of PC5 connection with relay user equipment fails;
a radio link failure of a Uu interface of the remote user equipment or a beam failure or a failure of performing beam failure recovery of the remote user equipment is detected;
synchronous reconfiguration of the PC5 interface and/or Uu interface of the remote user equipment fails; or
configuration of the PC5 interface and/or Uu interface of the remote user equipment fails.

In some embodiments, the notification of a radio link failure of a Uu interface of a relay user equipment or a failure of radio resource control connection of the relay user equipment or handover of the relay user equipment is transmitted via a PC5-RRC message.

In some embodiments, a failure of the indirect path includes at least one of the following:
that the failure of the radio link of the PC5 interface of the remote user equipment or the beam failure or the failure of performing beam failure recovery is detected;
that the notification of a radio link failure of a Uu interface of a relay user equipment or a failure of radio resource control connection of the relay user equipment or handover of the relay user equipment or a failure of beam failure recovery of the relay user equipment is received;
synchronous reconfiguration of the Uu interface of the remote user equipment fails;
Uu interface configuration of the remote user equipment fails; or
establishment of PC5 connection with the relay user equipment fails.

In some embodiments, a failure of the indirect path includes at least one of the following:
that a failure of the radio link or beam failure of the Uu interface of the remote user equipment or the failure of performing beam failure recovery is detected;
synchronous reconfiguration of the Uu interface of the remote user equipment fails; or
Uu interface configuration of the remote user equipment fails.

In some embodiments, the second path is an available path, the available path satisfying at least one of the following conditions that:
channel quality of the available path is higher than a first threshold;
channel quality of the available path satisfies criteria for cell selection and/or cell reselection;
channel quality of the available path satisfies criteria for relay selection and/or relay reselection;
the available path is an indirect path and no radio link failure or beam failure or beam failure recovery failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and synchronization reconfiguration failure of the PC5 interface of the remote user equipment does not occur on the indirect path;
the available path is an indirect path and configuration failure of the PC5 interface of the remote user equipment does not occur on the indirect path;
the available path is an indirect path and a failure of establishment of PC5 connection with the relay user equipment does not occur on the indirect path;
the available path is a direct path and a radio link failure or a beam failure or a failure of beam failure recovery of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or
the available path is not deactivated or de-configured.

In some embodiments, the channel quality of the path is a result of measuring the path by the remote user equipment, the result of measuring being Uu RSRP or SL-RSRP or SD-RSRP.

In some embodiments, the first threshold is predefined or is configurable.

In some embodiments, the failure information includes at least one of the following:
failure indication information, failure type information, a measurement result of a serving cell, measurement results of other cells and/or frequencies, a measurement result of a connected relay user equipment, or measurement results of other relay user equipments.

In some embodiments, the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

In some embodiments, the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

In some embodiments, information on the failure type is notified by the relay user equipment to the remote user equipment.

In some embodiments, the apparatus 1200 further includes:
a processing unit 1202 configured to trigger a radio resource control connection reestablishment procedure when both the first path and the second path fail.

In some embodiments, the processing unit 1202 triggers a radio resource control connection reestablishment procedure when the first path fails and the first path is a primary path.

In some embodiments, when the first path fails, the first path is a secondary path, the second path is available and the second path is a primary path, the transmitting unit 1201 transmits the failure information to a network device via the second path.

In some embodiments, the primary path and/or the secondary path is/are configured by the network device or is/are predefined.

In some embodiments, the failure information is transmitted via a radio resource control (RRC) message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 1200 for transmitting failure information may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the remote UE is configured or activated with more than one paths (a first path and a second path), and in the case where the first path fails, the remote UE transmits the failure information to the network device via the second path. Hence, interruption times of services of the user equipment may be reduced, transmission latency of the services may be ensured, and user experiences may be improved.

### Embodiments of a Third Aspect

The embodiments of this disclosure provide a method for receiving failure information, which may be carried out in a network device (such as the network device 403 described above), with contents identical to those in the embodiments of the first aspect being not going to be described herein any further.

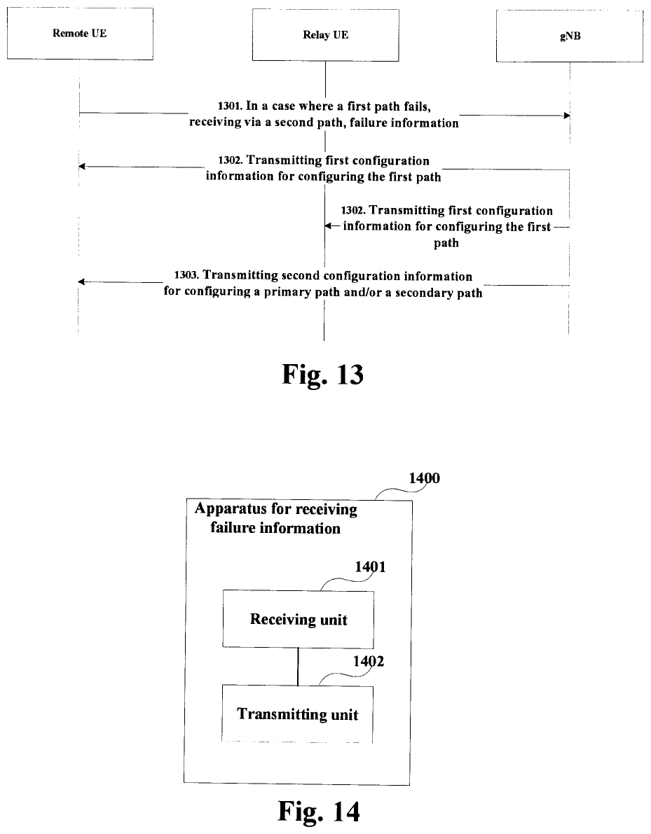

FIG. 13 is a schematic diagram of the method for receiving failure information of a third aspect of the embodiments of this disclosure. As shown in FIG. 13, the method includes:
1301: in a case where a first path fails, receiving via a second path, failure information transmitted by a remote user equipment, wherein the remote user equipment is configured or activated with a first path and the second path.

In some embodiments, the method further includes:
1302: transmitting first configuration information for configuring the first path to the remote user equipment or a relay user equipment according to the failure information.

In some embodiments, the first configuration information may include, for example, information for triggering the remote user equipment to perform relay selection or relay reselection, or may further include information for triggering the remote user equipment to perform an RRC reestablishment procedure, and so on. Reference may be made to relevant techniques for contents of the first configuration information.

In some embodiments, the method further comprises:
1303: transmitting second configuration information for configuring a primary path and/or a secondary path to the remote user equipment.

In some embodiments, the second configuration information may include, for example, an identifier or index of a path, a primary path indicator and/or a secondary path indicator, and so on. Reference may be made to relevant techniques for contents of the second configuration information.

In some embodiments, the first path may be a direct path, and the second path may be an indirect path; or, the first path may be an indirect path, and the second path may be a direct path.

In some embodiments, the failure information includes at least one of the following:
failure indication information, failure type information, a measurement result of a serving cell, measurement results of other cells and/or frequencies, a measurement result of a connected relay user equipment, or measurement results of other relay user equipments.

In some embodiments, the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

In some embodiments, the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

In some embodiments, the failure information is received via a radio resource control (RRC) message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiments that the remote UE is configured or activated with more than one paths (a first path and a second path), and in the case where the first path fails, the remote UE transmits the failure information to the network device via the second path. Hence, interruption times of services of the user equipment may be reduced, transmission latency of the services may be ensured, and user experiences may be improved.

### Embodiments of a Fourth Aspect

The embodiments of this disclosure provide an apparatus for receiving failure information. The apparatus may be, for example, a network device (such as the network device 403 described above), or may be one or some components or assemblies configured in the network device, with contents identical to those in the embodiments of the third aspect being not going to be described herein any further.

FIG. 14 is a schematic diagram of the apparatus for receiving failure information of the fourth aspect of the embodiments of this disclosure. As shown in FIG. 14, the apparatus 1400 for receiving failure information includes:
a receiving unit 1401 configured to, in a case where a first path fails, receive via a second path, failure information transmitted by a remote user equipment, wherein the remote user equipment is configured or activated with the first path and the second path.

In some embodiments, the apparatus 1400 further includes:
a transmitting unit 1402 configured to transmit first configuration information for configuring the first path to the remote user equipment or a relay user equipment according to the failure information.

In some embodiments, the transmitting unit 1402 transmits second configuration information for configuring a primary path and/or a secondary path to the remote user equipment.

In some embodiments, the first path is a direct path, and the second path is an indirect path; or, the first path is an indirect path, and the second path is a direct path.

In some embodiments, the failure information includes at least one of the following:
failure indication information, failure type information, a measurement result of a serving cell, measurement results of other cells and/or frequencies, a measurement result of a connected relay user equipment, or measurement results of other relay user equipments.

In some embodiments, the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

In some embodiments, the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

In some embodiments, the failure information is received via a radio resource control (RRC) message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 1400 for transmitting failure information may further include other components or modules, and reference may be made to related techniques for particulars of these components or modules.

Furthermore, for the sake of simplicity, connection relationships between the components or modules or signal profiles thereof are only illustrated in FIG. 14. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the remote UE is configured or activated with more than one paths (a first path and a second path), and in the case where the first path fails, the remote UE transmits the failure information to the network device via the second path. Hence, interruption times of services of the user equipment may be reduced, transmission latency of the services may be ensured, and user experiences may be improved.

### Embodiments of a Fifth Aspect

The embodiments of this disclosure provide a communication system, and reference may be made to FIG. 4, with contents identical to those in the embodiments of the first to the fourth aspects being not going to be described herein any further.

In some embodiments, the communication system 400 may at least include: a remote user equipment 401 and/or a network device 403 and/or a relay user equipment 402.

In the embodiments of this disclosure, the remote user equipment 401 may be configured to carry out the method for transmitting failure information in the embodiments of the first aspect, the contents of which being incorporated herein, which shall not be described herein any further.

In the embodiments of this disclosure, the network device 403 may be configured to carry out the method for receiving failure information in the embodiments of the third aspect, the contents of which being incorporated herein, which shall not be described herein any further.

The embodiments of this disclosure further provide a terminal equipment.

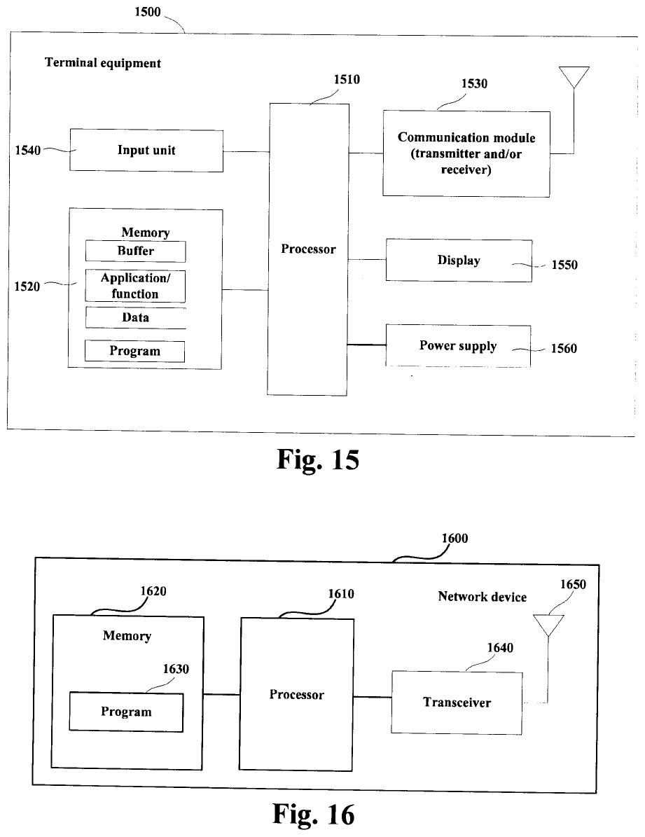

FIG. 15 is a schematic diagram of a structure of the terminal equipment of a fifth aspect of the embodiments of this disclosure. The terminal equipment may be a remote user equipment. As shown in FIG. 15, the terminal equipment 1500 may include a processor 1510 and a memory 1520, the memory 1520 storing data and a program and being coupled to the processor 1510. It should be noted that this figure is illustrative only, and other types of structures may also be used, so as to supplement or replace this structure and achieve a telecommunications function or other functions.

For example, the processor 1510 may be configured to execute a program to carry out the method for transmitting failure information in the embodiments of the first aspect. For example, the processor 1510 may be configured to executed the following operation: transmitting failure information to a network device via a second path in a case where a first path fails.

As shown in FIG. 15, the terminal equipment 1500 may further include a communication module 1530, an input unit 1540, a display 1550, and a power supply 1560, wherein functions of the above components are similar to those in the related art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

The embodiments of this disclosure further provides a network device, which may be, for example, a base station. However, this disclosure is not limited thereto, and it may also be another network device.

FIG. 16 is a schematic diagram of a structure of the network device of the embodiments of this disclosure. As shown in FIG. 16, the network device 1600 may include a processor 1610 (such as a central processing unit (CPU)) and a memory 1620, the memory 1620 being coupled to the processor 1610. The memory 1620 may store various data, and furthermore, it may store a program 1630 for information processing, and execute the program 1630 under control of the processor 1610.

For example, the processor 1610 may be configured to execute a program to carry out the method for receiving failure information in the embodiments of the third aspect. For example, the processor 1610 may be configured to executed the following operation: in a case where a first path fails, receiving via a second path, failure information transmitted by a remote user equipment, wherein the remote user equipment is configured or activated with a first path and the second path.

Furthermore, as shown in FIG. 16, the network device 1600 may include a transceiver 1640, and an antenna 1650, etc. Functions of the above components are similar to those in the related art, and shall not be described herein any further. It should be noted that the network device 1600 does not necessarily include all the parts shown in FIG. 16, and furthermore, the network device 1600 may include parts not shown in FIG. 16, and the related art may be referred to.

It can be seen from the above embodiments that the remote UE is configured or activated with more than one paths (a first path and a second path), and in the case where the first path fails, the remote UE transmits the failure information to the network device via the second path. Hence, interruption times of services of the user equipment may be reduced, transmission latency of the services may be ensured, and user experiences may be improved.

Embodiments of this disclosure provide a computer readable program, which, when executed in a remote user equipment, causes a computer to carry out the method for transmitting failure information as described in the embodiments of the first aspect in the remote user equipment.

Embodiments of this disclosure provide a computer storage medium, including a computer readable program, which causes a computer to carry out the method for transmitting failure information as described in the embodiments of the first aspect in a remote user equipment.

Embodiments of this disclosure provide a computer readable program, which, when executed in a network device, causes a computer to carry out the method for receiving failure information as described in the embodiments of the third aspect in the network device.

Embodiments of this disclosure provide a computer storage medium, including a computer readable program, which causes a computer to carry out the method for receiving failure information as described in the embodiments of the third aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.

1. An apparatus for transmitting failure information of a remote user equipment, the remote user equipment being configured or activated with a first path and a second path, the apparatus including:
a transmitting unit configured to transmit failure information to a network device via the second path in a case where the first path fails.

2. The apparatus according to supplement 1, wherein the path failure includes at least one of the following cases where:
a radio link failure of a PC5 interface of the remote user equipment or a beam failure or a failure of performing beam failure recovery is detected;
a notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
establishment of PC5 connection with relay user equipment fails;
a radio link failure of a Uu interface of the remote user equipment or a beam failure or a failure of performing beam failure recovery of the remote user equipment is detected;
synchronous reconfiguration of the PC5 interface and/or Uu interface of the remote user equipment fails; or
configuration of the PC5 interface and/or Uu interface of the remote user equipment fails.

3. The apparatus according to supplement 2, wherein,
the notification of a radio link failure of a Uu interface of a relay user equipment or a failure of radio resource control connection of the relay user equipment or handover of the relay user equipment is transmitted via a PC5-RRC message.

4. The apparatus according to supplement 1, wherein, the first path is a direct path, and the second path is an indirect path; or, the first path is an indirect path, and the second path is a direct path.

5. The apparatus according to supplement 4, wherein a failure of the indirect path includes at least one of the following:
that the failure of the radio link of the PC5 interface of the remote user equipment or the beam failure or the failure of performing beam failure recovery is detected;
that the notification of a radio link failure of a Uu interface of a relay user equipment or a failure of radio resource control connection of the relay user equipment or handover of the relay user equipment or a failure of beam failure recovery of the relay user equipment is received;
synchronous reconfiguration of the Uu interface of the remote user equipment fails;
Uu interface configuration of the remote user equipment fails; or
establishment of PC5 connection with the relay user equipment fails;

6. The apparatus according to supplement 4, wherein a failure of the indirect path includes at least one of the following:
that a failure of the radio link or beam failure of the Uu interface of the remote user equipment or the failure of performing beam failure recovery is detected;
synchronous reconfiguration of the Uu interface of the remote user equipment fails; or
Uu interface configuration of the remote user equipment fails.

7. The apparatus according to any one of supplements 1-6, wherein the second path is an available path, the available path satisfying at least one of the following conditions that:
channel quality of the available path is higher than a first threshold;
channel quality of the available path satisfies criteria for cell selection and/or cell reselection;
channel quality of the available path satisfies criteria for relay selection and/or relay reselection;
the available path is an indirect path and no radio link failure or beam failure or beam failure recovery failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and synchronization reconfiguration failure of the PC5 interface of the remote user equipment does not occur on the indirect path;
the available path is an indirect path and configuration failure of the PC5 interface of the remote user equipment does not occur on the indirect path;
the available path is an indirect path and a failure of establishment of PC5 connection with the relay user equipment does not occur on the indirect path;
the available path is a direct path and a radio link failure or a beam failure or a failure of beam failure recovery of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or the available path is not deactivated or de-configured.

8. The apparatus according to supplement 7, wherein,
the channel quality of the path is a result of measuring the path by the remote user equipment, the result of measuring being Uu RSRP or SL-RSRP or SD-RSRP.

9. The apparatus according to supplement 7 or 8, wherein,
the first threshold is predefined or is configurable.

10. The apparatus according to any one of supplements 1-9, wherein the failure information includes at least one of the following:
failure indication information, failure type information, a measurement result of a serving cell, measurement results of other cells and/or frequencies, a measurement result of a connected relay user equipment, or measurement results of other relay user equipments.

11. The apparatus according to supplement 10, wherein the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

12. The apparatus according to supplement 10, wherein the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

13. The apparatus according to supplement 12, wherein information on the failure type is notified by the relay user equipment to the remote user equipment.

14. The apparatus according to any one of supplements 1-13, wherein the apparatus further includes:
a processing unit configured to trigger a radio resource control connection reestablishment procedure when both the first path and the second path fail.

15. The apparatus according to any one of supplements 1-14, wherein the apparatus further includes:
a processing unit configured to trigger a radio resource control connection reestablishment procedure when the first path fails and the first path is a primary path.

16. The apparatus according to any one of supplements 1-15, wherein,
when the first path fails, the first path is a secondary path, the second path is available and the second path is a primary path, the transmitting unit transmits the failure information to a network device via the second path.

17. The apparatus according to supplement 15 or 16, wherein,
the primary path and/or the secondary path is/are configured by the network device or is/are predefined.

18. The apparatus according to supplement 1, wherein,
the failure information is transmitted via a radio resource control (RRC) message.

19. A method for transmitting failure information of a remote user equipment, the remote user equipment being configured or activated with a first path and a second path, the method including:

transmitting failure information to a network device via the second path in a case where the first path fails.

20. The method according to supplement 19, wherein the path failure includes at least one of the following cases where:
a radio link failure of a PC5 interface of the remote user equipment or a beam failure or a failure of performing beam failure recovery is detected;
a notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
establishment of PC5 connection with relay user equipment fails;
a radio link failure of a Uu interface of the remote user equipment or a beam failure or a failure of performing beam failure recovery of the remote user equipment is detected;
synchronous reconfiguration of the PC5 interface and/or Uu interface of the remote user equipment fails; or
configuration of the PC5 interface and/or Uu interface of the remote user equipment fails.

21. The method according to supplement 20, wherein,
the notification of a radio link failure of a Uu interface of a relay user equipment or a failure of radio resource control connection of the relay user equipment or handover of the relay user equipment is transmitted via a PC5-RRC message.

22. The method according to supplement 19, wherein,
the first path is a direct path, and the second path is an indirect path; or, the first path is an indirect path, and the second path is a direct path.

23. The method according to supplement 22, wherein a failure of the indirect path includes at least one of the following:
that the failure of the radio link of the PC5 interface of the remote user equipment or the beam failure or the failure of performing beam failure recovery is detected;
that the notification of a radio link failure of a Uu interface of a relay user equipment or a failure of radio resource control connection of the relay user equipment or handover of the relay user equipment or a failure of beam failure recovery of the relay user equipment is received;
synchronous reconfiguration of the Uu interface of the remote user equipment fails;
Uu interface configuration of the remote user equipment fails; or
establishment of PC5 connection with the relay user equipment fails;

24. The method according to supplement 22, wherein a failure of the indirect path includes at least one of the following:
that a failure of the radio link or beam failure of the Uu interface of the remote user equipment or the failure of performing beam failure recovery is detected;
synchronous reconfiguration of the Uu interface of the remote user equipment fails; or
Uu interface configuration of the remote user equipment fails.

25. The method according to any one of supplements 19-24, wherein the second path is an available path, the available path satisfying at least one of the following conditions that:
channel quality of the available path is higher than a first threshold;
channel quality of the available path satisfies criteria for cell selection and/or cell reselection;
channel quality of the available path satisfies criteria for relay selection and/or relay reselection;
the available path is an indirect path and no radio link failure or beam failure or beam failure recovery failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and synchronization reconfiguration failure of the PC5 interface of the remote user equipment does not occur on the indirect path;
the available path is an indirect path and configuration failure of the PC5 interface of the remote user equipment does not occur on the indirect path;
the available path is an indirect path and a failure of establishment of PC5 connection with the relay user equipment does not occur on the indirect path;
the available path is a direct path and a radio link failure or a beam failure or a failure of beam failure recovery of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or
the available path is not deactivated or de-configured.

26. The method according to supplement 25, wherein,
the channel quality of the path is a result of measuring the path by the remote user equipment, the result of measuring being Uu RSRP or SL-RSRP or SD-RSRP.

27. The method according to supplement 25 or 26, wherein,
the first threshold is predefined or is configurable.

28. The method according to any one of supplements 19-27, wherein the failure information includes at least one of the following:
failure indication information, failure type information, a measurement result of a serving cell, measurement results of other cells and/or frequencies, a measurement result of a connected relay user equipment, or measurement results of other relay user equipments.

29. The method according to supplement 28, wherein the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

30. The method according to supplement 28, wherein the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

31. The method according to supplement 30, wherein information on the failure type is notified by the relay user equipment to the remote user equipment.

32. The method according to any one of supplements 19-31, wherein the method further includes:
triggering an RRC connection reestablishment procedure when both the first path and the second path fail.

33. The method according to any one of supplements 19-32, wherein the method further includes:
triggering an RRC connection reestablishment procedure when the first path fails and the first path is a primary path.

34. The method according to any one of supplements 19-33, wherein the method further includes:
when the first path fails, the first path is a secondary path, the second path is available and the second path is a primary path, transmitting the failure information to a network device via the second path.

35. The method according to supplement 33 or 34, wherein,
the primary path and/or the secondary path is/are configured by the network device or is/are predefined.

36. The method according to supplement 19, wherein,
the failure information is transmitted via an RRC message.

37. A remote user equipment, including a memory and a processor, the memory storing a computer program, and the processor being configured to execute the computer program to carry out the method for transmitting failure information as described in any one of supplements 19-36.

38. An apparatus for receiving failure information, including:
a receiving unit configured to, in a case where a first path fails, receive via a second path, failure information transmitted by a remote user equipment, wherein the remote user equipment is configured or activated with the first path and the second path.

39. The apparatus according to supplement 38, wherein the apparatus further includes:
a transmitting unit configured to transmit first configuration information for configuring the first path to the remote user equipment or a relay user equipment according to the failure information.

40. The apparatus according to supplement 38, wherein the apparatus further includes:
a transmitting unit configured to transmit second configuration information for configuring a primary path and/or a secondary path to the remote user equipment.

41. The apparatus according to supplement 38, wherein,
the first path is a direct path, and the second path is an indirect path; or, the first path is an indirect path, and the second path is a direct path.

42. The apparatus according to any one of supplements 38-41, wherein the failure information includes at least one of the following:
failure indication information, failure type information, a measurement result of a serving cell, measurement results of other cells and/or frequencies, a measurement result of a connected relay user equipment, or measurement results of other relay user equipments.

43. The apparatus according to supplement 42, wherein the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

44. The apparatus according to supplement 42, wherein the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

45. The apparatus according to supplement 38, wherein,
the failure information is received via an RRC message.

46. A method for receiving failure information, including:
in a case where a first path fails, receiving via a second path, failure information transmitted by a remote user equipment, wherein the remote user equipment is configured or activated with the first path and the second path.

47. The method according to supplement 46, wherein the method further includes:
transmitting first configuration information for configuring the first path to the remote user equipment or a relay user equipment according to the failure information.

48. The method according to supplement 46, wherein the method further includes:
transmitting second configuration information for configuring a primary path and/or a secondary path to the remote user equipment.

49. The method according to supplement 46, wherein,
the first path is a direct path, and the second path is an indirect path; or, the first path is an indirect path, and the second path is a direct path.

50. The method according to any one of supplements 46-49, wherein the failure information includes at least one of the following:
failure indication information, failure type information, a measurement result of a serving cell, measurement results of other cells and/or frequencies, a measurement result of a connected relay user equipment, or measurement results of other relay user equipments.

51. The method according to supplement 50, wherein the failure indication information includes at least one of the following:
a Uu RLF (radio link failure of a Uu interface), a Uu BF (beam failure of a Uu interface), a Uu BFR (failure of beam failure recovery of a Uu interface), a PC5 RLF (radio link failure of a PC5 interface), a PC5 BF (beam failure of a PC5 interface), a PC5 BFR failure (failure of beam failure recovery of a PC5 interface), a Relay UE Uu RLF (radio link failure of the Uu interface of the relay user equipment), Relay UE HO (handover of the relay user equipment), a relay UE RRC failure (radio resource control connection failure of the relay user equipment), a relay UE BFR failure (failure of beam failure recovery), a PC5 connection failure (failure of establishment of PC5 connection), a Uu reconfiguration with sync failure (failure of synchronous reconfiguration of a Uu interface), a Uu configuration failure (failure of configuration of a Uu interface), a PC5 reconfiguration with sync failure (failure of synchronous reconfiguration of a PC5 interface) or a PC5 configuration failure (failure of configuration of a PC5 interface).

52. The method according to supplement 50, wherein the failure type information includes at least one of the following:
expiration of T310, a problem of random access, that a radio link failure reaches a maximum number of transmissions or retransmissions, that discontinuous transmissions of hybrid automatic retransmission request feedback reach a maximum number, an integrity failure, a listen-before-talk failure, a beam failure recovery failure, expiration of T312, a radio link failure of a backhaul link, or a failure type of transmission of the relay user equipment.

53. The method according to supplement 46, wherein,
the failure information is received via an RRC message.

54. A network device, including a memory and a processor, the memory storing a computer program, and the processor being configured to execute the computer program to carry out the method for receiving failure information as described in any one of supplements 46-53.

55. A communication system, including the network device as described in supplement 54
and/or the remote user equipment as described in supplement 37.

1. An apparatus for transmitting failure information of a remote user equipment, the remote user equipment being configured or activated with a first path and a second path, the apparatus comprising:
a transmitting unit configured to transmit failure information to a network device via the second path in a case where the first path fails.

2. The apparatus according to claim 1, wherein the path failure comprises at least one of the following cases where:
a radio link failure of a PC5 interface of the remote user equipment or a beam failure or a failure of performing beam failure recovery is detected;
a notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
establishment of PC5 connection with relay user equipment fails;
a radio link failure of a Uu interface of the remote user equipment or a beam failure or a failure of performing beam failure recovery of the remote user equipment is detected;
synchronous reconfiguration of the PC5 interface and/or Uu interface of the remote user equipment fails; or
configuration of the PC5 interface and/or Uu interface of the remote user equipment fail(s).

3. The apparatus according to claim 2, wherein,
the notification of a radio link failure of a Uu interface of a relay user equipment or a failure of radio resource control connection of the relay user equipment or handover of the relay user equipment is transmitted via a PC5-RRC message.

4. The apparatus according to claim 1, wherein,
the first path is a direct path, and the second path is an indirect path; or, the first path is an indirect path, and the second path is a direct path.

5. The apparatus according to claim 1, wherein the second path is an available path, the available path satisfying at least one of the following conditions that:
channel quality of the available path is higher than a first threshold;
channel quality of the available path satisfies criteria for cell selection and/or cell reselection;
channel quality of the available path satisfies criteria for relay selection and/or relay reselection;
the available path is an indirect path and no radio link failure or beam failure or beam failure recovery failure of the PC5 interface is detected on the indirect path;
the available path is an indirect path and no notification of a radio link failure of a Uu interface of a relay user equipment or a failure of radio resource control connection of the relay user equipment or handover of the relay user equipment or a failure of beam failure recovery of the relay user equipment transmitted by the relay user equipment is received;
the available path is an indirect path and synchronization reconfiguration failure of the PC5 interface of the remote user equipment does not occur on the indirect path;
the available path is an indirect path and configuration failure of the PC5 interface of the remote user equipment does not occur on the indirect path;
the available path is an indirect path and a failure of establishment of PC5 connection with the relay user equipment does not occur on the indirect path;
the available path is a direct path and a radio link failure or a beam failure or a failure of beam failure recovery of a PC5 interface is not detected on the direct path;
the available path is a direct path and no synchronization reconfiguration failure of the Uu interface of the remote user equipment occurs on the direct path;
the available path is a direct path and no Uu interface configuration failure of the remote user equipment occurs on the direct path; or
the available path is not deactivated or de-configured.

6. The apparatus according to claim 1, wherein the failure information comprises at least one of the following:
failure indication information, failure type information, a measurement result of a serving cell, measurement results of other cells and/or frequencies, a measurement result of a connected relay user equipment, or measurement results of other relay user equipments.

7. The apparatus according to claim 6, wherein the failure indication information comprises at least one of the following:
a radio link failure of a Uu interface, a beam failure of a Uu interface, a failure of beam failure recovery of a Uu interface, a radio link failure of a PC5 interface, a beam failure of a PC5 interface, a failure of beam failure recovery of a PC5 interface, a radio link failure of the Uu interface of the relay user equipment, handover of the relay user equipment, a radio resource control connection failure of the relay user equipment, a failure of beam failure recovery, a failure of establishment of PC5 connection, a failure of synchronous reconfiguration of a Uu interface, a failure of configuration of a Uu interface, a failure of synchronous reconfiguration of a PC5 interface and a failure of configuration of a PC5 interface of the relay user equipment.

8. The apparatus according to claim 1, wherein the apparatus further comprises:
a processing unit configured to trigger a radio resource control connection reestablishment process when both the first path and the second path fail, and/or, trigger a radio resource control connection reestablishment process when the first path fails and the first path is a primary path.

9. The apparatus according to claim 1, wherein,
when the first path fails, the first path is a secondary path, the second path is available and the second path is a primary path, the transmitting unit transmits the failure information to a network device via the second path.

10. The apparatus according to claim 9, wherein,
the primary path and/or the secondary path is configured by the network device or is predefined.

11. The apparatus according to claim 1, wherein,
the failure information is transmitted via a radio resource control message.

12. An apparatus for receiving failure information, comprising:
a receiving unit configured to, in a case where a first path fails, receive via a second path, failure information transmitted by a remote user equipment, wherein the remote user equipment is configured or activated with the first path and the second path.

13. The apparatus according to claim 12, wherein the apparatus further comprises:
a transmitting unit configured to transmit first configuration information for configuring the first path to the remote user equipment or a relay user equipment according to the failure information.

14. The apparatus according to claim 12, wherein the apparatus further comprises:
a transmitting unit configured to transmit second configuration information for configuring a primary path and/or a secondary path to the remote user equipment.

15. The apparatus according to claim 12, wherein,
the first path is a direct path, and the second path is an indirect path; or, the first path is an indirect path, and the second path is a direct path.

16. The apparatus according to claim 12, wherein the failure information comprises at least one of the following:
failure indication information, failure type information, a measurement result of a serving cell, measurement results of other cells and/or frequencies, a measurement result of a connected relay user equipment, or measurement results of other relay user equipments.

17. The apparatus according to claim 16, wherein the failure indication information comprises at least one of the following:
a radio link failure of a Uu interface, a beam failure of a Uu interface, a failure of beam failure recovery of a Uu interface, a radio link failure of a PC5 interface, a beam failure of a PC5 interface, a failure of beam failure recovery of a PC5 interface, a radio link failure of the Uu interface of the relay user equipment, handover of the relay user equipment, a radio resource control connection failure of the relay user equipment, a failure of beam failure recovery, a failure of establishment of PC5 connection, a failure of synchronous reconfiguration of a Uu interface, a failure of configuration of a Uu interface, a failure of synchronous reconfiguration of a PC5 interface and a failure of configuration of a PC5 interface of the relay user equipment.

18. The apparatus according to claim 12, wherein,
the failure information is received via a radio resource control message.

19. A communication system, comprising a remote user equipment and a network device, the remote user equipment being configured or activated with a first path and a second path, wherein,
the user equipment transmits failure information to the network device via the second path in a case where the first path fails,
the network device receives the failure information via the second path.
